(19) United States
(12) Patent Application Publication
(10) Pub. No.: US 2009/0230307 A1
(43) Pub. Date: Sep. 17, 2009

(54) Device to detect heat source, home appliance having the same and method of detecting heat source

(75) Inventors: Seong Joo Han, Yongin-si (KR); Kook Jeong Seo, Osan-si (KR); Jeong Su Han, Suwon-si (KR); Sung Hoon Kim, Suwon-si (KR); Su Ho Jo, Seongnam-si (KR); Hyen Young Choi, Suwon-si (KR); Sang Jun Lee, Suwon-si (KR); O Do Ryu, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/213,569

(22) Filed: Jun. 20, 2008

(30) Foreign Application Priority Data
Mar. 17, 2008 (KR) 10-2008-0024454

(51) Int. Cl. G01J 5/02

(52) U.S. Cl. 250/342

(57) ABSTRACT

A device to detect a heat source, which can detect position of a heat source faster and more efficiently using a sensor capable of detecting a heat source, a home appliance having such a detecting device and a method of detecting a heat source are disclosed. The heat source detecting method includes performing a first mode to scan an overall area to be searched, performing a second mode to scan at least one specific region included in the area to be searched, and detecting a heat source in the area to be searched by selectively controlling a sensor the first mode and the second mode. Accordingly, a period of renewing position information of a heat source is shortened, and unnecessary detecting operation is eliminated. As a result, the heat source detecting device can more efficiently detect a heat source, using a sensor having limited performance.

### CROSS-REFERENCE TO RELATED APPLICATIONS

This application claims the benefit of Korean Patent Application No. 2008-0024454, filed on Mar. 17, 2008 in the Korean Intellectual Property Office, the disclosure of which is incorporated herein by reference.

### BACKGROUND

1. Field

The present invention relates to a device to detect a heat source, a home appliance having the same and a method of detecting a heat source, and more particularly, to a device to detect a heat source, which can detect a position of a heat source faster and more efficiently using a sensor capable of detecting a heat source, a home appliance having such a detecting device and a method of detecting a heat source.

2. Description of the Related Art

According to the development of home appliances with higher performance, various techniques are being devised to maximize a using efficiency of home appliances. One of the techniques is to detect a position of a user of an appliance, to thereby more efficiently provide service to a user. Accordingly, the user's satisfaction is increased, and energy consumption can be optimized or minimized by making the appliance provide service only to a necessary portion. In this regard, there has been developed a device which detects a position of a human existing in an area to be searched, using a sensor capable of detecting a heat source.

Generally, all objects in nature radiate energies of respectively inherent wavelengths (infrared rays), and humans radiate an infrared ray of an inherent wavelength distinguished from other objects.

In order to measure temperatures from all of the heat sources, including humans, which radiate infrared rays of inherent wavelengths, a multichannel thermopile sensor (hereinafter, referred to as a heat detecting sensor), which detects infrared rays radiated from all of the heat sources in an area to be searched and thus measures a temperature of the area to be searched in a non-contact type, is used. A representative example using a heat detecting sensor is an air conditioner adapted to cool or heat an indoor space. By virtue of a heat detecting sensor mounted in an air conditioner to detect a position or movement of a human in real time, the air conditioner can provide a pleasant air conditioning environment to a user in such an air-conditioning pattern that a direction of an air current is controlled to be directed to a human or not to be directed to a human, and an air volume is properly controlled.

Because an area whose temperature can be measured by the heat detecting sensor is limited, in order to measure a temperature of a wider area, the heat detecting sensor is mounted to be rotated by a motor, to thereby scan the overall area to be searched and collect temperature information of the wider area. Based on the temperature information collected thus, the air conditioner provides necessary service to a specific position, i.e., a position at which a human is located or a position whose temperature is different from surroundings, e.g., a specific object which can move and emits heat in a certain place, such as a semiconductor production line.

However, in the aforementioned conventional heat detecting sensor which detects a position of a human through the repeated scanning operations to the overall area to be searched, a period of renewing information about the position of a human is determined from a detecting speed and a detecting range of the sensor at a certain point, dimensions of the area to be searched, a rotational speed of the motor, etc. Thus, if the period of renewing the information about the position of a human is large according to the properties of the sensor and the dimensions of the area to be searched, the conventional heat detecting sensor has a problem of not providing the most suitable service for the position of a human.

Such a problem due to the large renewal period may be solved by increasing a rotational speed of the motor in order to increase a detecting speed of the sensor or by using a sensor capable of detecting a wide range. However, such a solution requires a sensor with higher performance and a control part with higher performance to process the information from the sensor, which causes an increase in production costs of the system.

### SUMMARY

Therefore, it is an aspect of the embodiments to provide a device to detect a heat source, which includes plural modes to increase heat source detecting performance and converts the modes into each other according to circumstances in an area to be searched, so as to shorten a period of renewing position information of a heat source and eliminate unnecessary detecting operation, thereby detecting position of a heat source faster and more efficiently.

It is another aspect of the embodiments to provide a home appliance having the above device to detect a heat source.

It is a further aspect of the embodiments to provide a method of detecting a heat source using the above device.

Additional aspects and/or advantages will be set forth in part in the description which follows and, in part, will be obvious from the description, or may be learned by practice of the invention.

The foregoing and/or other aspects are achieved by providing a method of detecting a heat source, including: performing a first mode to scan an overall area to be searched; performing a second mode to scan at least one specific region included in the overall area to be searched; and detecting a heat source in the area to be searched by selectively controlling a sensor in accordance with the first mode and the second mode.

The at least one specific region may be a region in which the heat source is located and which is scanned to track movement of the heat source.

The specific region to be scanned may be changed according to movement of the heat source.

The first mode may be used to detect a position of the heat source, and the second mode may be used to track a movement of the detected heat source.

The first mode may be converted into the second mode to scan the specific region corresponding to the detected position of the heat source when the position of the heat source is detected using the first mode.

The second mode may be converted into the first mode when a predetermined time elapses during tracking movement of the heat source using the second mode.

The predetermined time may be a process time of the second mode.

The second mode may be converted into the first mode when the heat source stays in the at least one specific region over the predetermined time without movement during the tracking movement of the heat source using the second mode.

The second mode may be converted into the first mode when another heat source is detected during the tracking movement of the heat source using the second mode.

The specific region to be scanned in the second mode may be changed to track movement of the heat source when the at least one specific region includes plural specific regions.

The specific region to be scanned may be changed to include the plural specific regions and at least one intermediate region between the plural specific regions.

The foregoing and/or other aspects are achieved by providing a device to detect a heat source, comprising: at least one sensor to detect a position of a heat source in an overall area to be searched; and a control part including a first mode to scan the overall area to be searched and a second mode to scan at least one specific region included in the overall area to be searched, the control part selectively controlling the sensor by the first mode and the second mode.

The sensor may be configured as a heat detecting sensor to detect the position of the heat source located in the overall area to be searched by measuring a temperature value generated from the heat source.

The device may further include a stepping motor to drive the sensor. The control part may move the sensor to the left and right of the specific region at a predetermined angle by operation of the stepping motor, in order to track the movement of the heat source.

The at least one sensor may include a plurality of sensors arranged in an up/down direction, each of the plurality of sensors having a plurality of channels to detect left/right and front/back movement of the heat source.

The foregoing and/or other aspects are achieved by providing a home appliance, including: at least one sensor to detect a position of a heat source in an overall area to be searched; a sensor control part to detect the position of the heat source by scanning the overall area to be searched, and to track movement of the heat source by scanning a specific region corresponding to the detected position of the heat source; and an air conditioning control part to control an air conditioning operation according to the tracked movement of the heat source.

The home appliance may include an air conditioner or an air cleaner.

The home appliance may further include a stepping motor to drive the sensor left and right. The air conditioning control part may control an air direction by tracking left/right movement of the heat source by operation of the stepping motor.

The home appliance may further include a stepping motor to drive the sensor back and forth. The air conditioning control part may control an air volume or an air speed by tracking front/back movement of the heat source by operation of the stepping motor.

The at least one sensor may include a plurality of sensors arranged in an up/down direction, each of the plurality of sensors having a plurality of channels to detect front/back movement of the heat source, and the air conditioning control part may control an air volume or an air speed by tracking front/back movement of the heat source by use of the sensor.

The foregoing and/or other aspects are achieved by providing a method of detecting a heat source, including: performing a first mode to scan an overall area to detect a heat source; converting from the first mode to a second mode to scan at least one specific region included in the overall area to be searched in which the heat source is detected after the heat source is detected in the overall area; and performing the second mode to scan the at least one specific region.

The performing the second mode may include tracking a left/right movement and/or a front/back movement of the detected heat source in the at least one specific region.

The foregoing and/or other aspects are achieved by providing a method of detecting a plurality of heat sources, including: performing a first mode to scan an overall area to detect at least two heat sources; converting from the first mode to a second mode to scan at least the regions in which the heat sources are detected; and performing the second mode to scan at least the regions in which the heat sources are detected.

The second mode may additionally cause intermediate regions between the regions in which the heat sources are detected to be scanned.

### BRIEF DESCRIPTION OF THE DRAWINGS

These and/or other aspects and advantages of the embodiments will become apparent and more readily appreciated from the following description of the embodiments, taken in conjunction with the accompanying drawings, of which:

FIG. 1 is a perspective view illustrating an air conditioner mounted with a heat source detecting device according to an embodiment;

FIG. 2 is a schematic view illustrating the heat source detecting device according to the embodiment;

FIG. 3 is a control block diagram of the air conditioner mounted with the heat source detecting device according to the embodiment;

FIG. 4 is a view illustrating a first mode of scanning an overall area to be searched in the heat source detecting device according to the embodiment;

FIG. 5 is a view illustrating a second mode of scanning a specific region in the area to be searched in the heat source detecting device according to the embodiment;

FIGS. 6A and 6B are views illustrating a process of tracking left/right movement of a heat source in the specific region of FIG. 5;

FIGS. 7A and 7B are views illustrating a process of tracking front/back movement of a heat source in the specific region of FIG. 5;

FIG. 8 is an operational flow chart explaining a method of detecting a heat source, in which the first mode and the second mode are converted into each other in the heat source detecting device according to the embodiment; and

FIG. 9 is a view illustrating a third mode of scanning plural specific regions in the heat source detecting device according to an embodiment.

### DETAILED DESCRIPTION OF EMBODIMENTS

Reference will now be made in detail to the embodiments, examples of which are illustrated in the accompanying drawings, wherein like reference numerals refer to like elements throughout. The embodiments are described below to explain the present invention by referring to the figures.

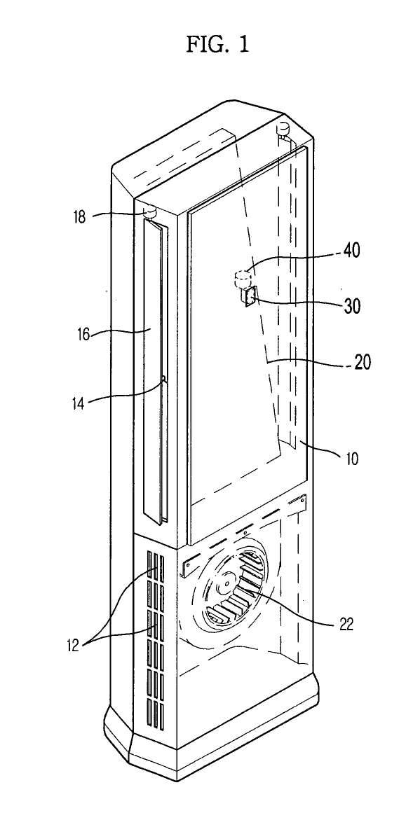

FIG. 1 is a perspective view illustrating an air conditioner mounted with a heat source detecting device according to an embodiment.

As shown in FIG. 1, an air conditioner 10 is formed with suction ports 12 at lower portions of both side surfaces, through which indoor air is sucked into the air conditioner 10, and discharge ports 14 at upper portions of both the side surfaces, through which the air sucked through the suction ports 12 is discharged to an indoor space.

A blade 16 is mounted to each of the discharge ports 14 in order to open or close the discharge port 14 and to adjust a direction of the discharged air. A driving motor 18 is mounted above the blade 16 in order to drive the blade 16. The blade 16 is connected to a rotating shaft of the driving motor 18 so that a rotational angle of the blade 16 is changed by the rotation of the driving motor 18. According to the change of the rotational angle of the blade 16, the direction of the air discharged through the discharge port 14 is adjusted, and also the discharge port 14 is opened or closed.

Inside the air conditioner 10 are mounted an indoor heat exchanger 20 which heat-exchanges the indoor air sucked through the suction port 12 with latent heat of vaporization of a refrigerant to generate cool air or warm air, and an indoor fan 22 to blow the air heat-exchanged by the indoor heat exchanger 20.

A heat source detecting device 30 is mounted to an upper portion of a front surface of the air conditioner 10 in order to detect a position of a heat source in a space, i.e., an area to be searched, in which the air conditioner 10 is mounted and to track left/right and front/back movement of the heat source. A stepping motor 40 is mounted adjacent to the heat source detecting device 30 in order to move the heat source detecting device 30 left and right with a predetermined interval, for example, approximately 30 to 60 seconds, at a speed capable of tracking the movement of the heat source, so that the heat source detecting device 30 scans the overall area to be searched and can track the movement of the heat source in real time.

The stepping motor 40 is configured as a variable reluctance-type stepping motor, for example, having a high rotational angle resolution to enable the heat source detecting device 30 to achieve a scanning mode requiring continuous movement as well as stepping movement.

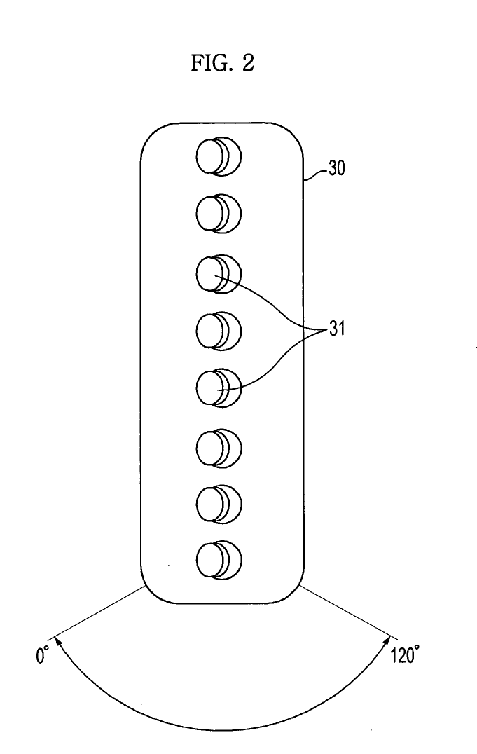

FIG. 2 is a schematic view illustrating the heat source detecting device according to the embodiment.

As shown in FIG. 2, the heat source detecting device 30 serves to measure a temperature of the overall area to be searched in order to detect a position of the heat source in the area to be searched and to track the left/right and front/back movement of a heat source. In order to detect a position of a heat source in the area to be searched, the heat source detecting device 30 includes heat detecting sensors 31 which detect an infrared ray through a plurality of channels and amplify output voltages and output temperature detecting voltages. Each of the heat detecting sensors 31 is configured as a multichannel thermopile sensor having a plurality of channels. The heat detecting sensors 31 are arranged in an up/down direction.

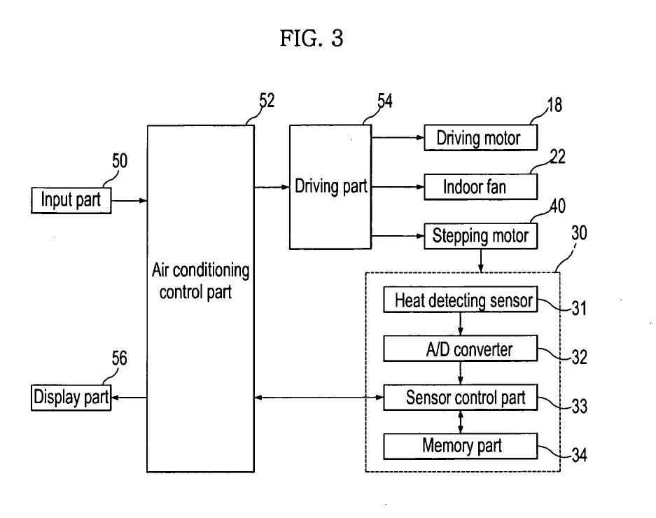

FIG. 3 is a control block diagram of the air conditioner mounted with the heat source detecting device according to the embodiment. As shown in FIG. 3, the air conditioner includes the aforementioned heat source detecting device 30, an input part 50, an air conditioning control part 52, a driving part 54 and a display part 56.

The heat source detecting device 30 includes the aforementioned multichannel heat detecting sensors 31, an A/D converter 32 to convert analog values corresponding to the temperature detecting voltages of the respective channels outputted from the heat detecting sensors 31 into digital voltage values, a sensor control part 33 to measure the temperature values of the respective channels corresponding to the digital voltage values from the A/D converter 32, and a memory part 34 to store a plurality of specific regions so that the heat detecting sensors 31 can scan the overall area to be searched. If the overall area to be searched, which is scanned by the heat detecting sensors 31, is from 0° to 120°, for example, one specific region is in the range of 5° to 10°, for example. However, the range of the specific region can be changed.

The memory part 34 stores a first mode of scanning the overall area to be searched, and a second mode of scanning the specific region in the area to be searched. Therefore, according to the movement of a heat source, the region to be scanned by the heat detecting sensors 31 is changed.

The sensor control part 33 detects a position of a heat source by scanning the overall area to be searched through the first mode, and tracks the left/right and front/back movement of the heat source by scanning the specific regions in the area to be searched, in which a heat source is detected, through the second mode. When performing the second mode, since the temperature information about only the necessary portions is collected, the amount of information to be processed is reduced, and accordingly a renewal period of the heat detecting sensors 31 can be shortened.

In more detail, the mode converting function of the sensor control part 33, by which the first mode and the second mode are converted into each other according to the movement of a heat source, can shorten a period of renewing information about the position of the heat source when compared to a conventional device to detect a heat source which repeatedly scans the overall area to be searched. Further, by eliminating the unnecessary detecting operation, the position of the heat source can be detected faster and more efficiently.

The present embodiment describes that the mode information of the heat detecting sensors 31 to change the area to be searched is separately stored in the memory part 34 of the heat source detecting device 30. However the present embodiment is not limited thereto. The mode information of the heat detecting sensors 31 can be stored in an internal memory of the air conditioning control part 52.

The input part 50 includes a key manipulating part, a remote control signal receiving part, or any other type of part that is capable of receiving the input of a user so that a user can input a user's desired operating mode, e.g., a cooling operation or heating operation, and operating information, such as a set temperature, a set air volume, a set air direction, etc.

The air conditioning control part 52 serves as a micom which controls the overall cooling or heating operation of the air conditioner 10 according to the operating mode inputted through the input part 50. Based upon the tracking information according to the position of the heat source detected by the heat source detecting device 30, the air conditioning control part 52 provides an air current, i.e., air direction and air volume, adequate to realize a pleasant air conditioning environment.

For example, the air conditioning control part 52 controls an air direction depending on the left/right movement of the heat source, or controls an air volume or an air speed depending on the front/back movement of the heat source, so that the heat-exchanged air can be supplied optimally for the position or movement of the heat source.

According to a control signal of the air conditioning control part 52, the driving part 54 controls the operation of the driving motor 18 which drives the blade 16 to adjust a discharged air direction, the operation of the indoor fan 22 which changes a discharged air volume, and the operation of the stepping motor 40 which reciprocatingly and horizontally moves the heat detecting sensor 31 to scan information of the heat source in the area to be searched.

According to a control signal of the air conditioning control part 52, the display part 56 displays information about the operated mode or position information of a heat source.

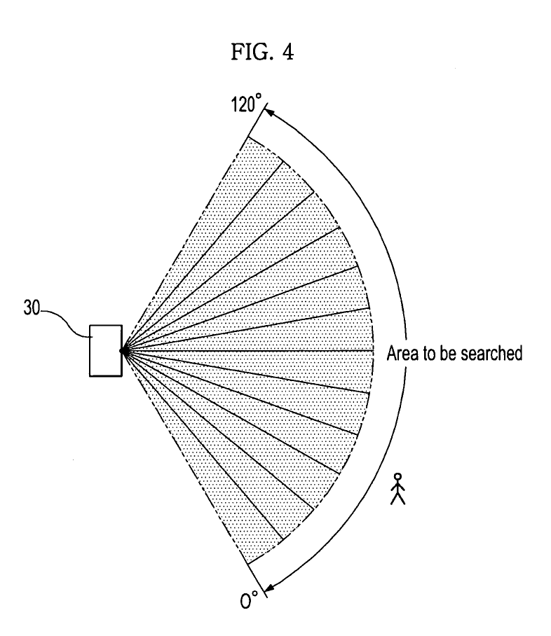

FIG. 4 is a view illustrating the first mode of scanning the overall area to be searched in the heat source detecting device according to the embodiment.

Referring to FIG. 4, the overall area to be searched, which is scanned by the heat source detecting device 30, is from 0° to 120°, for example. Through the first mode of scanning the overall area to be searched, the heat source detecting device 30 detects a heat source located in the area to be searched.

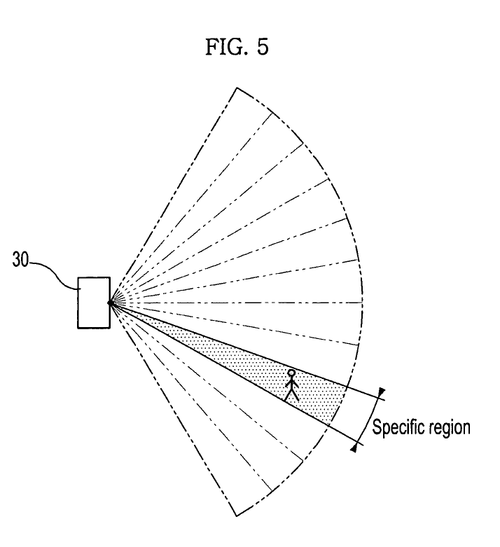

FIG. 5 is a view illustrating the second mode of scanning a specific region in the area to be searched in the heat source detecting device according to the embodiment of the present invention. The heat source detecting device 30 tracks the movement of the heat source in a specific region corresponding to the position of the heat source detected through the first mode shown in FIG. 4.

Referring to FIG. 5, the overall area to be searched, e.g., from 0° to 120°, which is scanned by the heat source detecting device 30, is sectioned into a plurality of specific regions, each of which is in the range of approximately 5° to 10°, for example. Through the second mode of scanning the specific region in the area to be searched, the heat source detecting device 30 tracks the movement of the heat source located in the specific region.

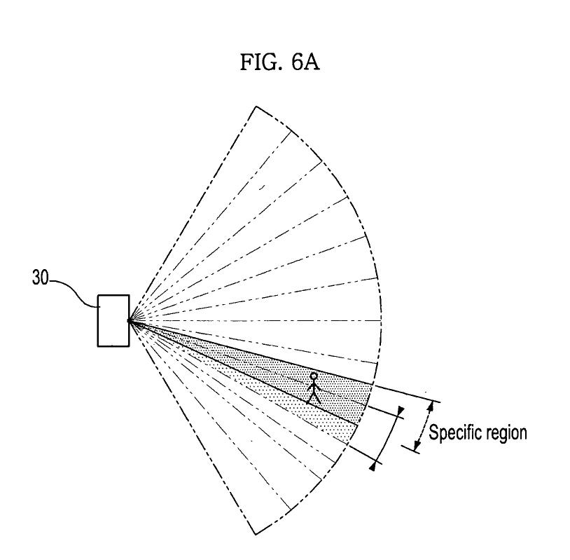

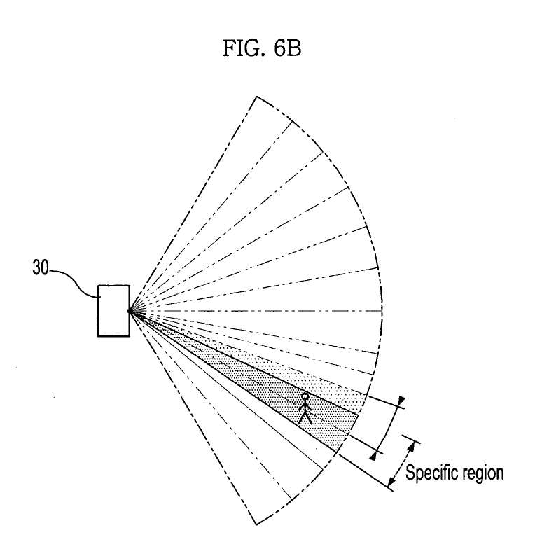

FIGS. 6A and 6B are views illustrating a process of tracking the left/right movement of a heat source in the specific region of FIG. 5, in which the specific region scanned by the heat source detecting device is changed according to the left/right movement of a heat source.

Referring to FIGS. 6A and 6B, the left/right movement of the heat source is tracked by rotating the heat detecting sensors 31 a left and right direction by 5° to 10°, for example, from the specific region in which the heat source is located. In a case where the heat source detecting device 30 is mounted in the air conditioner 10 as shown in FIG. 1, the air conditioner can set the optimum air direction based on the tracking information about the left/right movement of the heat source. For example, as shown in FIG. 6B, if a heat source moves left, the specific region scanned by the heat source detecting device 30 is changed to track the movement of the heat source, so that the heat-exchanged air is sufficiently blown toward the heat source.

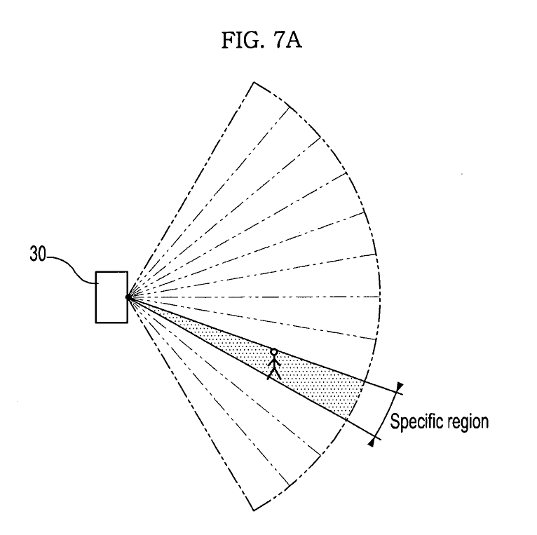

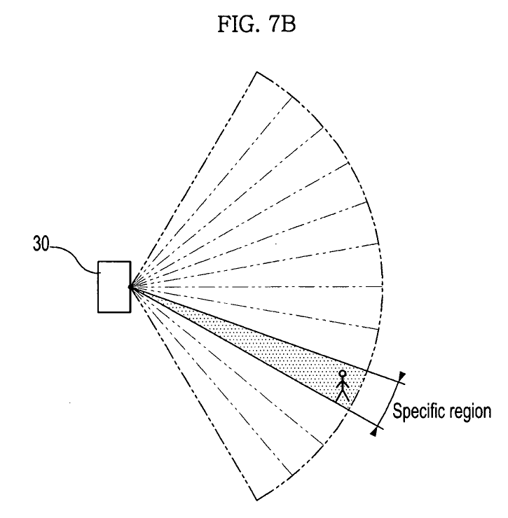

FIGS. 7A and 7B are views illustrating a process of tracking the front/back movement of a heat source in the specific region of FIG. 5, in which the specific region scanned by the heat source detecting device according to the front/back movement of a heat source is not changed.

Referring to FIGS. 7A and 7B, in a case where the heat source detecting device 30 is mounted in the air conditioner 10 as shown in FIG. 1, the air conditioner 10 can set the optimum air volume or air speed based on the tracking information about the front/back movement of the heat source. For example, as shown in FIG. 7B, if a heat source moves back while staying in the same specific region, the air conditioner 10 increases the air volume or air speed, so that the heat-exchanged air can be sufficiently supplied to a heat source.

Hereinafter, a method of detecting a heat source using the above-constituted heat source detecting device and an operational effect thereof will be explained.

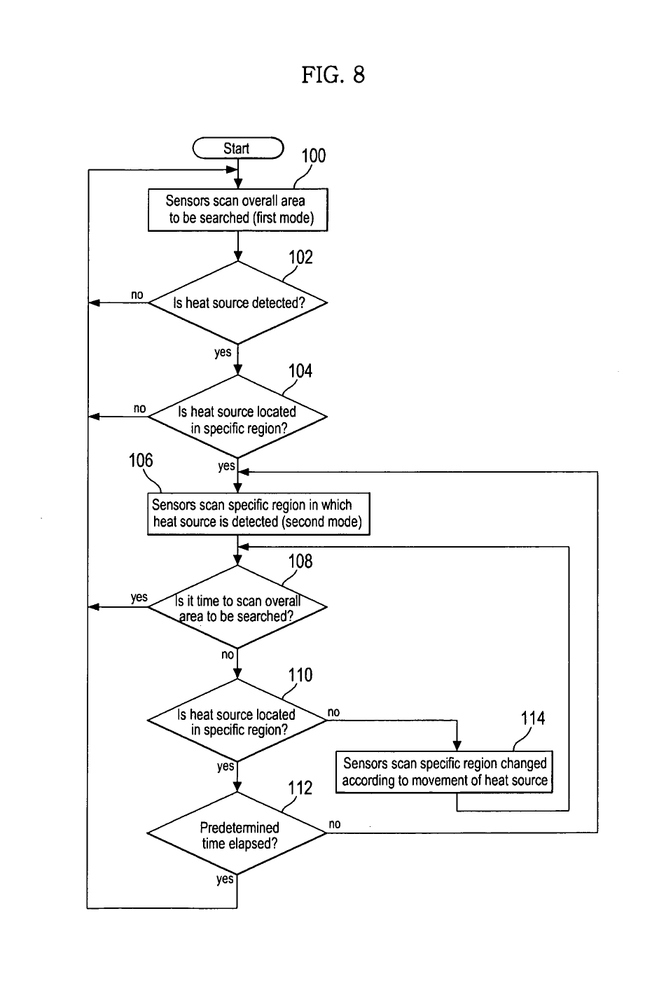

FIG. 8 is an operational flow chart explaining a method of detecting a heat source, in which the first mode and the second mode are converted into each other in the heat source detecting device according to the embodiment.

In order for the heat source detecting device 30 to detect a position of a heat source in the area to be searched, the stepping motor 40 is driven to move the heat detecting sensors 31 left and right at a speed capable of tracking the movement of the heat source. Thereby, as shown in FIG. 4, the first mode, in which the heat detecting sensors 31 scan the overall area to be searched, is performed at operation 100.

While moving left and right at a regular speed, the heat detecting sensors 31 detect an infrared ray radiated from a heat source, i.e., a human or a certain object which can move and emits heat, in the overall area to be searched, which is sectioned into a plurality of specific regions, and output temperature detecting voltages. The analog values corresponding to the temperature detecting voltages of the respective channels outputted from the heat detecting sensors 31 are converted into digital voltage values by the A/D converter 32, and the digital voltage values are transmitted to the sensor control part 33.

The sensor control part 33 receives the temperature values of the respective specific regions corresponding to the digital voltage values from the A/D converter 32, and calculates a mean temperature value of all the specific regions. After comparing the temperature values of the respective specific regions with the calculated mean value, if the temperature value of the specific region is larger than the mean value, the sensor control part 33 stores the corresponding specific region and detects position information of a heat source.

Thereafter, the sensor control part 33 determines whether a heat source is detected in the first mode, at operation 102. If it is determined that a heat source is detected, the sensor control part 33 determines whether a heat source is still located in the same specific region after the first mode is completed, at operation 104.

If a heat source is detected in the first mode, the first mode is converted into the second mode of tracking the movement of a heat source by scanning only the specific region in which the heat source is detected. At this time, after the heat source is detected in the first mode, the first mode is not unconditionally converted into the second mode. Only when the heat source is still located in the same specific region after the first mode is completed is the first mode converted into the second mode to track the movement of the heat source. If the heat source frequently moves in the first mode, a positional reference point to track the movement of the heat source cannot be determined. Thus, the first mode cannot be converted into the second mode.

From the determination result of operation 104, if it is determined that the heat source is not located in the same specific region after the first mode is completed, the process goes back to operation 100 to perform the first mode. If it is determined that the heat source is still located in the same specific region after the first mode is completed, as shown in FIG. 5, the sensor control part 33 performs the second mode in which the heat detecting sensors 31 scan the specific region in which the heat source is detected, at operation 106.

Thereafter, the sensor control part 33 tracks the movement of the heat source located in the specific region through the second mode, and determines whether it is time to scan the overall area to be searched during tracking the movement of a heat source, at operation 108.

If it is determined that it is time to scan the overall area to be searched, the process goes back to operation 100 to convert the second mode into the first mode in order to re-scan the overall area to be searched. If it is determined that it is not time to scan the overall area to be searched, the sensor control part 33 redetermines whether a heat source is still located in the same specific region, at operation 110. While the movement of the heat source is tracked in the second mode, if the heat source stays in the same specific region over a predetermined time without movement, the second mode is converted into the first mode.

From the determination result of operation 110, if it is determined that the heat source is located in the same specific region, it is determined whether the heat source stays in the same specific region without movement over a predetermined time, at operation 112. If it is determined that a heat source stays in the same specific region over a predetermined time, the process goes back to operation 100 to convert the second mode into the first mode in order to re-scan the overall area to be searched.

From the determination result of operation 110, if it is determined that a heat source is not located in the same specific region, it means that the heat source moves while the movement thereof is tracked in the second mode. Therefore, the second mode, in which the specific region to be scanned is changed according to the movement of the heat source and is scanned by the heat detecting sensors 31, is performed at operation 114, and then the process goes back to operation 108.

From the determination result of operation 112, if it is determined that the heat source does not stay in the same specific region over a predetermined time, the process goes back to operation 106 to continuously perform the second mode so that the specific region in which the heat source is detected is scanned by the heat detecting sensors 31.

As described above, through the heat source detecting method of converting the first mode and the second mode into each other, even though using the heat detecting sensors 31 having the same performance as conventional ones, the heat source detecting device 30 of the present embodiment can generate an operational effect similar to when using heat detecting sensors of high performance. Accordingly, the position information of a heat source can be renewed faster and more accurately, thereby providing optimum service to a user.

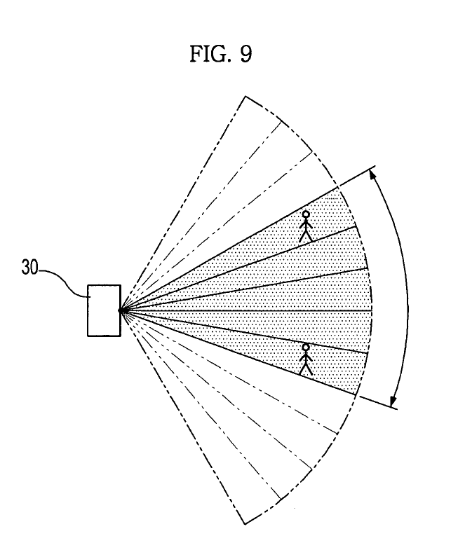

FIG. 9 is a view illustrating a third mode of scanning plural specific regions in the heat source detecting device according to an embodiment. When the specific regions corresponding to the positions of heat sources detected using the first mode shown in FIG. 4 are two or more, the third mode is performed to track the movement of heat sources.

As shown in FIG. 9, when the positions of the heat sources detected in the first mode are two or more, the sensor control part 33 tracks the movement of heat sources by scanning the specific regions in which the heat sources are located and the intermediate specific regions therebetween.

Alternatively, the sensor control part 33 may track the movement of the heat sources by alternately scanning only the specific regions in which heat sources are located. At this time, the heat source detecting device may be configured not to scan the intermediate specific regions between the specific regions in which heat sources are located, or may be configured to scan the intermediate specific regions with a low resolution to an extent of roughly detecting circumstances of the intermediate specific regions.

Although the present embodiments have been described with reference to the air conditioner, the present embodiments are not limited to the air conditioner. The present embodiments can also be applied to any home appliances using heat source detection, such as an air cleaner, a semiconductor production line, etc.

As apparent from the above description, the device and method of detecting a heat source includes the plural modes to increase the heat source detecting performance, and converts the modes into each other according to the circumstances in the area to be searched. Accordingly, a period of renewing the position information of a heat source can be shortened, and unnecessary detecting operation is eliminated. As a result, the heat source detecting device can more efficiently detect a heat source, using sensors having limited performance.

Although embodiments have been shown and described, it would be appreciated by those skilled in the art that changes may be made in these embodiments without departing from the principles and spirit of the invention, the scope of which is defined in the claims and their equivalents.

What is claimed is:

1. A method of detecting a heat source, comprising:
performing a first mode to scan an overall area to be searched;
performing a second mode to scan at least one specific region included in the overall area to be searched; and
detecting a heat source in the area to be searched by selectively controlling a sensor in accordance with the first mode and the second mode.

2. The method according to claim 1, wherein the at least one specific region is a region in which the heat source is located and which is scanned to track movement of the heat source.

3. The method according to claim 2, wherein the specific region to be scanned is changed according to movement of the heat source.

4. The method according to claim 1, wherein the first mode is used to detect a position of the heat source, and the second mode is used to track a movement of the detected heat source.

5. The method according to claim 4, wherein the first mode is converted into the second mode to scan the specific region corresponding to the detected position of the heat source when the position of the heat source is detected using the first mode.

6. The method according to claim 4, wherein the second mode is converted into the first mode when a predetermined time elapses during tracking movement of the heat source using the second mode.

7. The method according to claim 6, wherein the predetermined time is a process time of the second mode.

8. The method according to claim 6, wherein the second mode is converted into the first mode when the heat source stays in the at least one specific region over the predetermined time without movement during the tracking movement of the heat source using the second mode.

9. The method according to claim 4, wherein the second mode is converted into the first mode when another heat source is detected during tracking movement of the heat source using the second mode.

10. The method according to claim 2, wherein the specific region to be scanned in the second mode is changed to track movement of the heat source when the at least one specific region includes plural specific regions.

11. The method according to claim 10, wherein the specific region to be scanned is changed to include the plural specific regions and at least one intermediate region between the plural specific regions.

12. A device to detect a heat source, comprising:
at least one sensor to detect a position of a heat source in an overall area to be searched; and
a control part including a first mode to scan the overall area to be searched and a second mode to scan at least one specific region included in the overall area to be searched, the control part selectively controlling the sensor by the first mode and the second mode.

13. The device according to claim 12, wherein the sensor is configured as a heat detecting sensor to detect the position of the heat source located in the overall area to be searched by measuring a temperature value generated from the heat source.

14. The device according to claim 12, wherein the specific region is a region in which the heat source is located and which is scanned to track movement of the heat source by the sensor.

15. The device according to claim 14, wherein the specific region to be scanned is changed according to the movement of the heat source.

16. The device according to claim 12, further comprising:
a stepping motor to drive the sensor, the control part moving the sensor left and right of the specific region at a predetermined angle by operation of the stepping motor in order to track movement of the heat source.

17. The device according to claim 12, wherein the at least one sensor includes a plurality of sensors arranged in an up/down direction, each of the plurality of sensors having a plurality of channels to detect left/right and front/back movement of the heat source.

18. A home appliance, comprising:
at least one sensor to detect a position of a heat source in an overall area to be searched;
a sensor control part to detect the position of the heat source by scanning the overall area to be searched, and to track movement of the heat source by scanning a specific region corresponding to the detected position of the heat source; and
an air conditioning control part to control an air conditioning operation according to the tracked movement of the heat source.

19. The home appliance according to claim 18, wherein the home appliance includes an air conditioner or an air cleaner.

20. The home appliance according to claim 18, further comprising:
a stepping motor to drive the sensor left and right, the air conditioning control part controlling an air direction by tracking left/right movement of the heat source by operation of the stepping motor.

21. The home appliance according to claim 18, further comprising:
a stepping motor to drive the sensor back and forth, the air conditioning control part controlling an air volume or an air speed by tracking front/back movement of the heat source by operation of the stepping motor.

22. The home appliance according to claim 18, wherein the at least one sensor includes a plurality of sensors arranged in an up/down direction, each of the plurality of sensors having a plurality of channels to detect front/back movement of the heat source, the air conditioning control part controlling an air volume or an air speed by tracking front/back movement of the heat source by use of the sensor.
